(19) United States
(12) Patent Application Publication
(10) Pub. No.: US 2026/0358873 A1
(43) Pub. Date: Nov. 12, 2026

(54) MANAGING WAKE REQUESTS IN DEVICES

(71) Applicant: QUALCOMM Incorporated, San Diego, CA (US)

(72) Inventors: Ujjwal LNU, Muzaffarpur (IN); Srikanth RAPOLU, Hyderabad (IN)

(21) Appl. No.: 19/204,096

(22) Filed: May 9, 2025

(51) Int. Cl. G06F 1/3206; G06F 1/3287; G06F 15/78

(52) U.S. Cl. CPC G06F 1/3206; G06F 1/3287; G06F 15/7807

(57) ABSTRACT

A host system-on-chip (SoC) is disclosed. The host SoC may be included in a device. The host SoC may generate low priority wake requests in a low power state of the device and queue the generated wake requests, in a monitoring interval. The host SoC may execute the queued wake requests based on one of: an expiry of the monitoring interval, a number of the queued one or more wake requests exceeding a threshold value in the monitoring interval, or a reception of a high priority wake request in the monitoring interval. The device may transition to an active state based on the execution of the wake requests.

### FIELD OF THE DISCLOSURE

The present disclosure relates generally to electronic systems, and, more particularly, to management of wake requests in electronic devices.

### DESCRIPTION OF RELATED ART

Wake-up events transition a device from an idle mode to an active mode. The wake-up events can be generated within the device or received from external sources. A wake-up event instructs the device to perform one or more operations associated with the wake-up event. In the absence of a user input or other activity for a configured period of time, the device may transition into the idle mode or a reduced power state to limit power consumption. While in the idle mode, one or more components of the device may be disabled or placed in a reduced functionality state to lower the overall power usage. Upon detection of a wake-up event, the device transitions from the idle mode to the active mode to initiate execution of operations corresponding to the wake-up event.

If a large number of wake-up events are generated or received over a period of time, the device may transition repeatedly between the idle mode and the active mode. Each transition from the idle mode to the active mode may result in power consumption due to the reactivation of one or more hardware components and the initiation of one or more processing tasks. As the number of wake-up events increases, the frequency of such transitions may also increase, thereby resulting in higher power usage by the device. As device usage increases, there are opportunities to optimize power consumption and enhance device longevity.

### SUMMARY

Aspects of the disclosure provide a system-on-chip (SoC). The SoC may comprise an event control circuit configured to queue one or more wake requests associated with a first category, in a monitoring interval, and execute the queued one or more wake requests based on one of: an expiry of the monitoring interval, a number of the queued one or more wake requests exceeding a threshold value in the monitoring interval, or a reception of a wake request associated with a second category in the monitoring interval.

In certain aspects of the disclosure, a device may be disclosed. The device comprises a host SoC, a connectivity interface, and one or more processing circuits coupled to the host SoC via the connectivity interface. The host SoC may be configured to: queue one or more wake requests associated with a first category, in a monitoring interval; and execute the queued one or more wake requests based on one of: an expiry of the monitoring interval, a number of the queued one or more wake requests exceeding a threshold value in the monitoring interval, or a reception of a wake request associated with a second category in the monitoring interval. The one or more processing circuits may be configured to transition from an idle mode to an active mode based on the execution of the queued one or more wake requests.

In certain aspects, a method executed by an SoC is disclosed. The method may comprise queueing one or more wake requests associated with a first category, in a monitoring interval. The method may further comprise executing the queued one or more wake requests based on one of: an expiry of the monitoring interval, a number of the queued one or more wake requests exceeding a threshold value in the monitoring interval, or a reception of a wake request associated with a second category in the monitoring interval.

### BRIEF DESCRIPTION OF THE DRAWINGS

Various aspects of the present disclosure are illustrated by way of example, and not limited by the appended figures, in which like references indicate similar elements:

FIG. 1 is a schematic block diagram of a device, in accordance with certain aspects of the present disclosure;

FIG. 2 is a high-level flowchart that illustrates a method (e.g., a process) executed by a host system-on-chip (SoC) of the device of FIG. 1, in accordance with an exemplary aspect of the present disclosure;

FIG. 3 is a high-level flowchart that illustrates a method (e.g., a process) executed at the device of FIG. 1, in accordance with an exemplary aspect of the present disclosure;

FIG. 4 is a flowchart that illustrates a method (e.g., a process) executed by the host SoC of FIG. 2 based on a number of low priority wake requests exceeding a threshold value, in accordance with an exemplary aspect of the present disclosure;

FIG. 5 is a flowchart that illustrates a method (e.g., a process) executed by the host SoC of FIG. 2 based on an expiry of a monitoring interval, in accordance with further aspects of the present disclosure;

FIG. 6 is a flowchart that illustrates a method (e.g., a process) executed by the host SoC of FIG. 2 based on a high priority wake request, in accordance with furthermore aspects of the present disclosure;

FIG. 7 is a flowchart that illustrates a method (e.g., a process) executed by a timer of the host SoC of FIG. 2, in accordance with an exemplary aspect of the present disclosure; and

FIG. 8 is a flowchart that illustrates a method (e.g., a process) executed by an event control circuit of the host SoC of FIG. 2, in accordance with an exemplary aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, an event control circuit, one or more processing circuits, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

A device may include a system on a chip (SoC), a connectivity interface, and a modem processor coupled to the SoC via the connectivity interface. The connectivity interface may be in various operational states based on an activity of the device. In one example, a first state may be an M0 state or an active state. Further, a second state may be an M3 state or a power down state, a low-power state, an idle state, or an inactive state (e.g., a power-saving state). The connectivity interface may be in the M3 state based on one or more circuitries (e.g., the SoC, the modem processor, or the like) of the device being in the low-power state. A long standby battery life of the device may thus be achieved by allowing the circuitries to remain in the low-power state for a prolonged time period.

In the low-power state of the device, a networking subsystem or a user interface circuit of the device may initiate wake-up events for incoming emails, Voice over Internet Protocol (VoIP) calls, or the like. Further, the SoC may execute scripts or applications that may generate wake-up events to transition the device to the active state. The connectivity interface may be trained based on the wake-up events, to transition from the M3 state to the M0 state. Further, the modem processor and various circuitries coupled to the SoC via the connectivity interface may wake-up, thereby transitioning the device into the active state. Frequent transitions of the device to the active state may consume a large number of processing cycles of the SoC and result in power consumption of the device.

Certain aspects disclosed herein provide methods, circuits, and systems that are adapted to manage wake requests in devices. For example, a host SoC of the device may queue first category wake requests having a low priority in a monitoring interval, and execute the queued first category wake requests based on one of the following criteria: an expiry of the monitoring interval, a number of the queued first category wake requests exceeding a threshold value in the monitoring interval, or a reception of a second category wake request having a high priority in the monitoring interval.

The overlapping execution of multiple first category wake requests may result in lower power consumption as compared to conventional devices that transition to the active mode in response to each individual wake request. By aggregating the first category wake requests and executing the aggregated first category wake requests collectively, frequent retraining of a connectivity interface that couples the host SoC to various circuitries of the device may be avoided. Thus, the connectivity interface may be trained once in association with the execution of the aggregated first category wake requests, thereby reducing the number of interface training operations. Additionally, the device may remain in the idle state for a longer duration and transition to the active state based on the occurrence of any one of the previously described criteria, prior to the occurrence of the remaining criteria.

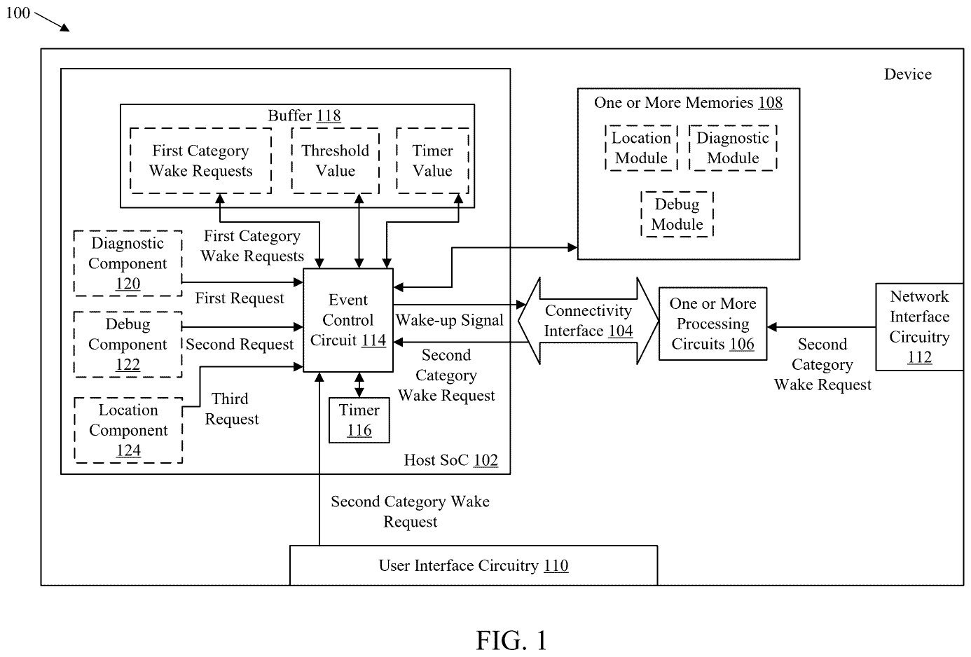

FIG. 1 is a schematic block diagram of a device 100, in accordance with certain aspects of the present disclosure. The device 100 may include a host system-on-chip (SoC) 102, a connectivity interface 104, one or more processing circuits 106, one or more memories 108, a user interface circuitry 110, and a network interface circuitry 112. The host SoC 102 may be coupled to the one or more processing circuits 106 and the network interface circuitry 112 via the connectivity interface 104. Further, the host SoC 102 may be coupled to the user interface circuitry 110. In certain aspects, the device 100 may be implemented in automotive systems, home automation systems, mobile devices, robotic systems, healthcare systems, immersive reality systems, Internet of Things (IoT) systems, or the like. However, it will be understood by a person skilled in the art that the device 100 may be implemented in various additional or alternate systems. Further, the device 100 may be a cellular phone, a laptop, a notebook, a tablet, a phablet, a personal digital assistant, a satellite radio, a global positioning system device, a smart home device, intelligent lighting, a multimedia device, a video device, a digital audio player, a camera, a game console, an entertainment device, a vehicle component, a wearable computing device (e.g., a smartwatch, a health or fitness tracker, or eyewear), an appliance, a security device, a vending machine, a smart meter, or any other similar functioning device.

The host SoC 102 included in the device 100, may be a processing chip that integrates multiple components to facilitate desired functions of the host SoC 102. In one example, the desired functions of the host SoC 102 may include generation of a wake-up signal to transition the device 100 from a first operational state (e.g., an idle state) to a second operational state (e.g., an active state). In aspects of the present disclosure, the host SoC 102 may be configured to generate and provide the wake-up signal via the connectivity interface 104 to the one or more processing circuits 106 thereby transitioning the one or more processing circuits 106 from an idle state to an active state.

An idle state may refer to a low power state, hybrid sleep state, a partial operational state, or a modern standby state. The device 100 may be in the idle state based on an absence of a wake request received from any of the user interface circuitry 110 (e.g., circuitry associated with a keyboard, a Universal Serial Bus (USB) device, or the like), the network interface circuitry 112 (e.g., circuitry associated with a wired network that may include Local Area Network (LAN)), a wireless network that may include a cellular network, Bluetooth, or the like. A wake request may trigger a transition of the device 100 from the idle mode to the active state. Further, the device 100 may switch from the idle state to the active state in response to the wake request received from any of the user interface circuitry 110 or the network interface circuitry 112. The power consumed by the device 100 in the idle state is lower than the power consumed by the device 100 in the active state.

The active state may refer to a fully operational state of the device 100. The device 100 may actively transmit and receive data to/from external devices, thereby consuming higher power in the active state as compared to the idle state. The device 100 may be in the active state based on a presence of the wake request received from any of the user interface circuitry 110 or the network interface circuitry 112. Further, the device 100 may transition from the active state to the idle state based on an absence of the wake request associated with any of the user interface circuitry 110 or the network interface circuitry 112 for a predefined time period. In addition, the device 100 may transition from the idle state to the active state based on execution of accumulated wake-up requests generated by the host SoC 102 as explained in the ongoing disclosure.

The host SoC 102 may generate the wake-up signal based on one or more wake requests associated with a first category (alternatively referred to as “first category wake requests”) or a wake request associated with a second category (alternatively referred to as a “second category wake request”). The one or more wake requests associated with the first category are different from the wake request associated with the second category. The first category may be indicative of a first priority level and the second category may be indicative of a second priority level. Further, the second priority level may be higher than the first priority level. Further stated, the first category wake requests may be low priority or non-critical wake requests, whereas the second category wake request may be a high priority or critical wake requests.

The host SoC 102 may associate a wake request with a first category or a second category. In one aspect, the host SoC 102 may associate a wake request with one of the first category or the second category based on a source of generation of the wake request. For example, a wake request generated within the host SoC 102 may be associated with the first category, whereas a wake request received from any of the user interface circuitry 110 or the network interface circuitry 112 may be associated with the second category. The user interface circuitry 110 may initiate a wake request of the second category based on a reception of a user input via a keyboard, touchscreen, a mouse, or the like, associated with the device 100. Further, the network interface circuitry 112 may initiate a wake request of the second category based on a reception of data packets from a network. In some aspects, the host SoC 102 may receive a wake request associated with the second category from at least one of the user interface circuitry 110 or the network interface circuitry 112. Thus, a wake request associated with the second category may include at least one of a user-initiated wake request or a network-initiated wake request.

In some aspects, the host SoC 102 may be configured to generate the one or more wake requests associated with the first category based on execution of scripts, applications, or codes, stored in the one or more memories 108. In one example, the host SoC 102 may generate or initiate the one or more wake requests associated with the first category based on execution of at least one of a location module, a diagnostic module, a debug module, or the like, stored in the one or more memories 108. Thus, the one or more wake requests associated with the first category may include at least one of a location-based wake request (alternatively referred to as a “first request”), a diagnosis-based wake request (alternatively referred to as a “second request”), a debug-based wake request (alternatively referred to as a “third request”), or the like.

The host SoC 102 may be further configured to queue the one or more wake requests associated with the first category in a monitoring interval. The monitoring interval may be a time period to queue the one or more wake requests associated with the first category. The host SoC 102 may be further configured to execute the queued one or more wake requests based on criteria, which includes one of the following: an expiration of the monitoring interval, a number of the queued one or more wake requests exceeding a threshold value in the monitoring interval, or the reception of the second category wake request in the monitoring interval. The wake-up signal may be generated to initiate the execution of the queued one or more wake requests. Thus, the host SoC 102 may queue the one or more wake requests having a low priority and execute the queued wake requests collectively based on the aforementioned criteria. The queueing and collective execution of the one or more wake requests having low priority may ensure that a number of transitions from the idle state to the active state may be reduced as compared to transitioning the device 100 from the idle state to the active state with each low priority wake request.

In some aspects, the components of the host SoC 102 may include an event control circuit 114, a timer 116, a buffer 118, a diagnostic component 120, a debug component 122, a location component 124, or the like. The event control circuit 114 may include suitable circuitry that may be configured to perform one or more operations. In one example, the event control circuit 114 may be configured to receive first through third requests associated with the first category from the diagnostic component 120, the debug component 122, or the location component 124, respectively, and generate the wake-up signal. In further examples, the event control circuit 114 may be configured to execute one or more functions associated with the diagnostic component 120, the debug component 122, or the location component 124. Further stated, the event control circuit 114 can generate the one or more wake requests associated with the first category. In further examples, the event control circuit 114 may retrieve the diagnostic module, the debug module, or the location module from the one or more memories 108 to generate the first request, the second request, or the third request, respectively. In further examples, the event control circuit 114 may control the generation of the wake requests. Further stated, the event control circuit 114 may control at least one of the diagnostic component 120, the debug component 122, and the location component 124 to generate the first, second, and third requests, respectively. In some aspects, the event control circuit 114 may be a processor or a processing core of the host SoC 102.

In further aspects, the event control circuit 114 may include at least one of the diagnostic component 120, the debug component 122, and the location component 124. In further aspects, a processor of the host SoC 102 may be configured to execute operations of the event control circuit 114 and further execute the diagnostic module associated with the diagnostic component 120, the debug module associated with the debug component 122, and the location module associated with the location component 124. In further aspects, a controller may be coupled to the event control circuit 114, and control at least one of the diagnostic component 120, the debug component 122, and the location component 124. In further aspects, the controller may include the diagnostic component 120, the debug component 122, and the location component 124. In further aspects, each of the diagnostic component 120, the debug component 122, and the location component 124 may correspond to one or more circuitries of the host SoC 102. For the sake of simplicity of explaining the ongoing disclosure, it is assumed that the event control circuit 114 may receive at least one of the first, second, and third requests, from the diagnostic component 120, the debug component 122, and the location component 124, respectively. Further stated, the event control circuit 114 may detect the first, second, and third requests.

The event control circuit 114 may be further configured to receive at least one of the one or more wake requests associated with the first category and the wake request associated with the second category based on the device 100 being in the idle state. A wake request may include information associated with the execution of the wake request. In one example, the information may include a wake identifier indicative of a source of initiating the wake request, a time instance of initiating the wake request, code or instructions associated with the execution of the wake request, or the like. The event control circuit 114 may thus determine the source of the wake request based on the identifier to associate the wake request with the first category or the second category. To further associate the wake request with the first category or the second category, the event control circuit 114 may further determine whether a wake request is associated with turning ON a display screen of the device 100 (e.g., the user has input data by way of a keyboard, touchscreen, USB peripheral, or the like to turn ON the display screen) or the wake request has been received from a cellular datapath of the network (e.g., the network interface circuitry 112) and may include information associated with a voice call, ping packets, a short message service (SMS), a flash message, an instant message, a social media message, emergency services, or the like. The one or more wake requests associated with the first category may be queued for execution, whereas the wake request associated with the second category may be executed instantly. Examples of the event control circuit 114 214 may include, but are not limited to, a processor, a microcontroller, or the like.

The event control circuit 114 may queue during the monitoring interval, the one or more wake requests associated with the first category in the buffer 118. Further stated, the event control circuit 114 may maintain a number or count of the one or more wake requests associated with the first category. The monitoring interval may be configurable or predefined. Further stated, the event control circuit 114 may be further configured to set the monitoring interval based on one or more operational parameters associated with the host SoC 102. The one or more operational parameters associated with the host SoC 102 may include a power-based parameter, a location-based parameter, or the like. In one scenario, the device 100 (e.g., the host SoC 102) may be in a remote area, e.g., low traffic area. Thus, the monitoring interval may be set to a first time period (e.g., 20 hours, 2 days, or the like). In further scenarios, the device 100 (e.g., the host SoC 102) may be in a congested area, e.g., a high traffic area. Thus, the monitoring interval may be set to a second time period (e.g., 20 minutes, 2 hours, or the like). In further scenarios, the monitoring interval may be set with a predefined time period based on historical data associated with the monitoring interval that may be stored in the one or more memories 108.

In one aspect, with the reception of the one or more wake requests associated with the first category in the monitoring interval, the event control circuit 114 may queue the one or more wake requests associated with the first category until the expiry of the monitoring interval. Further, the event control circuit 114 may trigger the timer 116 based on an arrival of an initial wake request of the one or more wake requests associated with the first category. The timer 116 may increment until the expiry of the monitoring interval. In one scenario, further wake requests associated with the first category may be queued until the expiry of the monitoring interval. The timer 116 may generate a timeout signal at the expiry of the monitoring interval. The event control circuit 114 may thus determine that the monitoring interval has expired based on the timeout signal. Upon the reception of the timeout signal, the event control circuit 114 may execute the queued wake requests in the buffer 118.

In some aspects, the event control circuit 114 may be configured to execute the queued first category wake requests based on the determination that the number of the queued first category wake requests has exceeded the threshold value. The threshold value may be a value to track a number of the wake requests associated with the first category. In one example, the threshold value may be set to three. The event control circuit 114 may receive the first through third requests and queue the first through third requests in the buffer 118 in the monitoring interval. Thus, the queued first through third requests may be executed to transition the device 100 from the first operational state to the second operational state based on the number of the queued first through third requests exceeding the threshold value.

The threshold value may be configurable or predefined. Further stated, the event control circuit 114 may be further configured to set the threshold value based on one or more operational parameters associated with the host SoC 102. The one or more operational parameters associated with the host SoC 102 may include power-based parameters, a service-based parameter indicating emergency or critical services, or the like. In one example, the device 100 may be an IoT device located in a remote area. Thus, the threshold value may be set to a first value (e.g. 100, 500, or the like). Further, if the device 100 is utilized for any emergency or critical services in an accident-prone area, the threshold value may be set to a second value (e.g. 3, 5, or the like).

In further aspects, the event control circuit 114 may be further configured to determine whether the wake request associated with the second category is received in the monitoring interval. In an example, at least one of the network interface circuitry 112 or the user interface circuitry 110 may provide the wake request associated with the second category to the event control circuit 114 in the monitoring interval. In one scenario, the wake request associated with the second category may be received after queueing any of the first request or the second request in the buffer 118 in the monitoring interval. Upon the reception of the wake request associated with the second category, the event control circuit 114 may execute the wake request associated with the second category along with the queued one or more wake requests associated with the first category (e.g., at least one of the first request or the second request).

The disclosure further teaches a solution to resolve the scenarios stated herein. In one scenario, the monitoring interval may be set to 10 hours. Further, the second request may be triggered after 5 minutes from the first request, the third request may be triggered after 5 hours from the first request, and a fourth request may be triggered after 9 hours from the first request. Thus, the execution of the first request may be delayed until the expiry of the monitoring interval (e.g., after 10 hours). In further scenarios, the monitoring interval may be set to 5 minutes and 100 wake requests associated with the first category may be received by the event control circuit 114. Queueing of a large number of the wake requests in the buffer 118 may create a load on the buffer 118 and further create a processing load during execution of the 100 wake requests.

To optimize the execution of the one or more wake requests associated with the first category, the event control circuit 114 may determine any one of the criteria (e.g., the expiry of monitoring interval, the number of the queued one or more wake requests exceeding the threshold value, or the wake request associated with the second category) that may occur prior to the remaining aforesaid criteria, to generate the wake-up signal. In one scenario, the monitoring interval may expire prior to the number of the queued one or more wake requests exceeding the threshold value or the reception of the wake request associated with the second category. In further scenarios, the number of the queued one or more wake requests may exceed the threshold value in the monitoring interval prior to the expiry of the monitoring interval or the reception of the wake request associated with the second category. In further scenarios, the wake request associated with the second category may be received in the monitoring interval prior to the expiry of the monitoring interval or the number of the queued one or more wake requests exceeding the threshold value. Thus, as compared to relying on a single criterion, the disclosure determines whichever of the three above stated criterion occurs prior to the remaining criteria, thereby reducing the processing load on the device 100 to execute the queued one or more wake requests. In the disclosure, the usage of “prior to” does not necessarily mean that the remaining criteria may occur.

The timer 116 may be associated with the monitoring interval. The event control circuit 114 may be further configured to trigger the timer 116 based on an initial wake request associated with the first category. The timer 116 may be a linear timer or a logarithmic timer. The timer 116 may be configured to be incremented linearly or logarithmically until one of the expiry of the monitoring interval, the number of the queued one or more wake requests exceeding the threshold value in the monitoring interval, or the reception of the wake request associated with the second category in the monitoring interval. In one aspect, the timer 116 may reset based on the expiry of the monitoring interval. In further aspects, the timer 116 may be configured to be reset by the event control circuit 114 based on one of the queued one or more wake requests exceeding the threshold value or the reception of the wake request associated with the second category. In one example, the timer 116 may increment linearly from a first time instance (e.g., 0^{th} minute) to a second time instance (e.g., 1 minute), further to a third time instance (e.g., 2 minutes), and so on, until the expiry of the monitoring interval (e.g., 20 minutes). In further examples, to increment logarithmically up to 20 minutes, the timer 116 may be incremented based on Equation (1).

Equation (1) states, Log₂t=x+1, where x may be a whole number (e.g., 0, 1, 2, 3, or the like) and ‘t’ may be a value of the timer 116. The monitoring interval may be divided into a number of time periods that may be incremented logarithmically. The initial value of the timer 116 may be ‘t=1 minute’, as ‘Log₂1=0’ based on the triggering of the timer 116. After the triggering of the timer 116, ‘x’ may be ‘0’, thus ‘x+1’ may be ‘1’ and the timer 116 may be incremented based on the next value for a first time period, e.g., ‘Log₂2=1’. For a second time period, ‘x’ may be ‘1’, thus ‘x+1’ may be ‘2’ and ‘Log₂4=2’. For the third time period, ‘x’ may be ‘2’ thus ‘x+1’ may be ‘3’, thus ‘Log₂8=3’, e.g., ‘t’ may be 8. Thus, the timer 116 may be incremented logarithmically (e.g., from 1 to 2 to 4 to 8 minutes) until one of following: the expiry of the monitoring interval, the queued one or more wake requests associated with the first category exceeding the threshold value, or the reception of the wake request associated with the second category in the monitoring interval. The timer 116 may be re-initialized with ‘Log₂T=0’ after the reset.

The buffer 118 may be configured to store the first category wake requests, the threshold value, and a timer value (e.g., a value of the monitoring interval). Further stated, the event control circuit 114 may be further configured to queue (e.g. temporarily store) the one or more wake requests in the buffer 118. Queueing of the one or more wake requests may not necessarily refer to an order of execution of the one or more wake requests. The event control circuit 114 may be further configured to clear the buffer 118 based on the execution of the queued one or more wake requests. In one aspect, the buffer 118 may be a cache memory. In various aspects, the first category wake requests may be stored in the one or more memories 108.

The diagnostic component 120 may be associated with execution of the diagnostic module to initiate the first request. The diagnostic module may include a set of codes or instructions associated with the diagnosis of one or more circuitries or software components of the device 100. Further stated, the diagnostic module may include code or instructions to diagnose operational or structural faults in the one or more circuitries.

The debug component 122 may be configured to generate the second request, based on the execution of the debug module. The debug module may include a set of codes or instructions associated with debugging of errors in the one or more circuitries or software components of the device 100.

The location component 124 may be configured to generate the third request based on the execution of the location module. The location module may include a set of codes or instructions associated with an identification of the location of the device 100. The location module may refer to code or instructions associated with detection of a geographical location of the device 100. Based on the detected location, various services related to weather, convenience-based services that may include food delivery, or the like, may be further initiated by the host SoC 102.

The connectivity interface 104 may be a Peripheral Component Interconnect Express (PCIe) link. The connectivity interface 104 may be trained to execute the one or more wake requests associated with the first category based on reception of the wake-up signal from the host SoC 102 or the wake request associated with the second category. In one example, the host SoC 102 may detect the one or more processing circuits 106 coupled via the connectivity interface 104 to the host SoC 102. Both the host SoC 102 and the one or more processing circuits 106 exchange training sequences to align based on link width and speed. Upon the successful configuration of the link width and speed, the host SoC 102 and the one or more processing circuits 106 negotiate and configure link parameters that include a number of lanes and the data rate for communication on the connectivity interface 104. Further, the signal quality may be adjusted to ensure reliable data transmission between the host SoC 102 and the one or more processing circuits 106 thereby compensating for any signal degradation that may occur over the connectivity interface 104.

In one aspect, the host SoC 102 may initiate the training over the connectivity interface 104. In further aspects, the one or more processing circuits 106 may initiate the training over the connectivity interface 104 based on the second category wake request (e.g., on reception of data packets from the network by the network interface circuitry 112). Though FIG. 1 shows that the host SoC 102 may be coupled to the one or more processing circuits 106 via the connectivity interface 104, in various aspects, the host SoC 102 may be coupled to various different circuitries (e.g., the user interface circuitry 110) of the device 100 via the connectivity interface 104.

The one or more processing circuits 106 may include a baseband processor that may process signals received from the network via the network interface circuitry 112 and provide the processed data to the host SoC 102. The one or more processing circuits 106 may remain in the idle state based on absence of the signals from the network or the wake-up signal from the host SoC 102. Examples of the one or more processing circuits 106 may include, but are not limited to, an application specific integrated circuit (ASIC) processor, a Reduced Instruction Set Computer (RISC), a Complex Instruction Set Computer (CISC), a field-programmable gate array (FPGA), or the like.

The one or more memories 108 may be configured to store the location module, the diagnostic module, the debug module, or the like. The one or more memories 108 may be controlled by the host SoC 102 and one or more processing circuits 106. Examples of the one or more memories 108 may include a random-access memory (RAM), a read only memory (ROM), a programmable ROM (PROM), an erasable PROM (EPROM), an electrically erasable PROM (EEPROM), and any other suitable medium for storing commands, software, and/or instructions that may be accessed and read by the host SoC 102. In further aspects, the one or more memories 108 may be a non-transitory computer-readable medium. Though the one or more memories 108 show the diagnostic module, the location module, and the debug module, various additional or alternate modules may be stored in the one or more memories 108. An example of one of the alternate modules may be a network module.

The user interface circuitry 110 may be configured to provide the second category wake request to the host SoC 102. The second category wake request may be generated based on the user input received via the user interface circuitry 110. The user interface circuitry 110 may include various devices that may be configured to communicate with the host SoC 102. Examples of the devices may include a keyboard, a mouse, a joystick, a touchscreen, a display screen, a microphone, a speaker, headphones, and the like.

The network interface circuitry 112 may be configured to provide the second category wake request or the network-initiated wake request based on a communication received from the network. The one or more processing circuits 106 may communicate with the network via the network interface circuitry 112. Examples of the network interface circuitry 112 may include an antenna, a switch, a radio frequency transceiver, a wireless transceiver, a Bluetooth transceiver, an Ethernet port, a USB port, or the like.

In operation, the device 100 may be in the first operational state (e.g., a low power or idle state). In a non-limiting example, the event control circuit 114 may configure the value of the monitoring interval to be 20 minutes and configure the threshold value to three. The event control circuit 114 may configure the value of the monitoring interval and the threshold value during a boot-up or the transition of the device 100 from the active state to the low power state. In further aspects, the event control circuit 114 may retrieve the predefined values of the monitoring interval and the threshold from the one or more memories 108 or the buffer 118.

The event control circuit 114 may receive the first request associated with the diagnostic component 120. Further, the event control circuit 114 may queue the first request in the buffer 118 and simultaneously trigger the timer 116 to increment until the expiry of the monitoring interval. The event control circuit 114 may wait until the expiry of the monitoring interval to receive the timeout signal from the timer 116.

In one scenario, after 4 minutes from the queueing of the first request, the event control circuit 114 may receive the second request from the debug component 122 and queue the second request in the buffer 118. In one example, no further wake requests associated with the first category may be received in the monitoring interval. Further, the wake request associated with the second category may not be received in the monitoring interval. At the end or expiry of the monitoring interval, the timer 116 may timeout and generate the timeout signal. Further, the timer may reset at the expiry of the monitoring interval. The event control circuit 114 may thus execute the queued first request and the second request. Based on the execution of the first request and the second request, the device 100 may transition to the active state, thereby initiating the diagnosis and debugging of associated circuitries. The event control circuit 114 may further clear the buffer 118.

In further scenarios, the event control circuit 114 may receive the second request at the 10^{th} minute after the first request. The event control circuit 114 may further receive the third request at the 18^{th} minute and queue the third request in the buffer 118. The event control circuit 114 may further determine that the number of queued first through third requests has exceeded the threshold value of 3. The event control circuit 114 may thus trigger the diagnosis operation, debug operation, and location detection, based on the execution of the first request, the second request, and the third request, respectively. Further, the one or more processing circuits 106 may transition from the idle state to the active state based on the execution of the queued first through third requests, thereby transitioning the device 100 to the active state. The event control circuit 114 may further reset the timer and clear the buffer 118.

In further scenarios, the event control circuit 114 may receive the second category wake request from the user interface circuitry 110 in the monitoring interval, after the reception of the first request. As the event control circuit 114 may determine that the second category wake request may be a critical wake request, the event control circuit 114 may execute the second category wake request along with the first request. To execute the first request and the second category wake request, the training of the connectivity interface 104 may occur. Further, the execution of the second category wake request may turn ON the display of a display screen of the device 100. In addition, the event control circuit 114 may initiate the diagnosis of a component indicated by the first request. The event control circuit 114 may further reset the timer and clear the buffer 118.

It will be understood by a person skilled in the art that the second category wake request may include requests associated with different circuitries of the device 100.

It will be understood by a person skilled in the art that though the diagnostic component 120, the debug component 122, or the location component 124 are shown in FIG. 1, in various aspects, the first category wake request may include different requests associated with different components of the host SoC 102. Furthermore, in some aspects, the first category wake request may be generated by components that may be external to the host SoC 102.

In one aspect, the device 100 may transition to a preceding operational state based on the generation of the wake-up signal.

In some aspects, the timer 116 may be a software timer maintained in the event control circuit 114.

In some aspects, the event control circuit 114 may store the first category wake requests, the threshold value, and the timer value in a register of the event control circuit 114.

In some aspects, the threshold value and the timer value may be stored in the one or more memories 108, and may be retrieved by the event control circuit 114 based on the initial wake request.

In further aspects, the host SoC 102 may be configured to execute one or more operations associated with the event control circuit 114 based on execution of a set of instructions or code stored in the one or more memories 108. In some aspects, the event control circuit 114 may be a software code stored in the one or more memories 108 which may be executed on a host processor of the host SoC 102.

In some aspects, the diagnostic component 120, the debug component 122, and the location component 124 may be software components that may be executed on the event control circuit 114 and stored in the one or more memories 108. In some aspects, the diagnostic component 120, the debug component 122, and the location component 124 may be hardware circuitry coupled to the event control circuit 114. In some aspects, the diagnostic component 120, the debug component 122, and the location component 124 may be a combination of hardware and software components.

In some aspects, the user interface circuitry 110 may be coupled to the host SoC 102 via the connectivity interface 104. Further, the host SoC 102 may provide the wake-up signal to the user interface circuitry 110.

In some aspects, the host SoC 102 may execute the one or more wake requests associated with the first category based on an order of reception of the one or more wake requests associated with the first category.

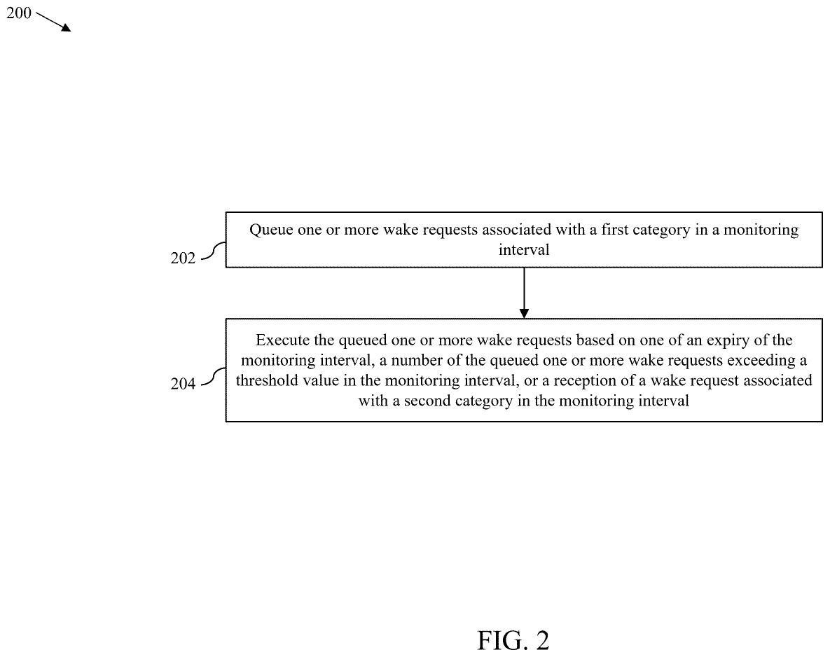

FIG. 2 is a high-level flowchart 200 that illustrates a method (e.g., a process) executed by the host SoC 102 of the device 100 of FIG. 1, in accordance with an exemplary aspect of the present disclosure. FIG. 2 is explained in conjunction with FIG. 1.

At 202, one or more wake requests associated with a first category in a monitoring interval may be queued. In one example, the one or more wake requests associated with the first category may include the first, second, and third requests and the first request may be the initial wake request. The timer 116 may thus be triggered based on the initial wake request. Further, the event control circuit 114 may queue the received one or more wake requests associated with the first category.

At 204, the queued one or more wake requests may be executed based on one of an expiry of the monitoring interval, a number of the queued one or more wake requests exceeding a threshold value in the monitoring interval, or a reception of a wake request associated with a second category in the monitoring interval. In one scenario, if the monitoring interval may expire prior to any of the number of the queued one or more wake requests exceeding the threshold value or the reception of the wake request associated with the second category in the monitoring interval, the event control circuit 114 may execute the queued one or more wake requests. In further scenarios, if the number of the queued one or more wake requests exceeds the threshold value in the monitoring interval prior to any of the expiry of the monitoring interval or the reception of the wake request associated with the second category in the monitoring interval, the event control circuit 114 may execute the queued one or more wake requests. In furthermore scenarios, if the wake request associated with the second category is received in the monitoring interval prior to any of the expiry of the monitoring interval or the number of the queued one or more wake requests exceeding the threshold value in the monitoring interval, the event control circuit 114 may execute the queued one or more wake requests.

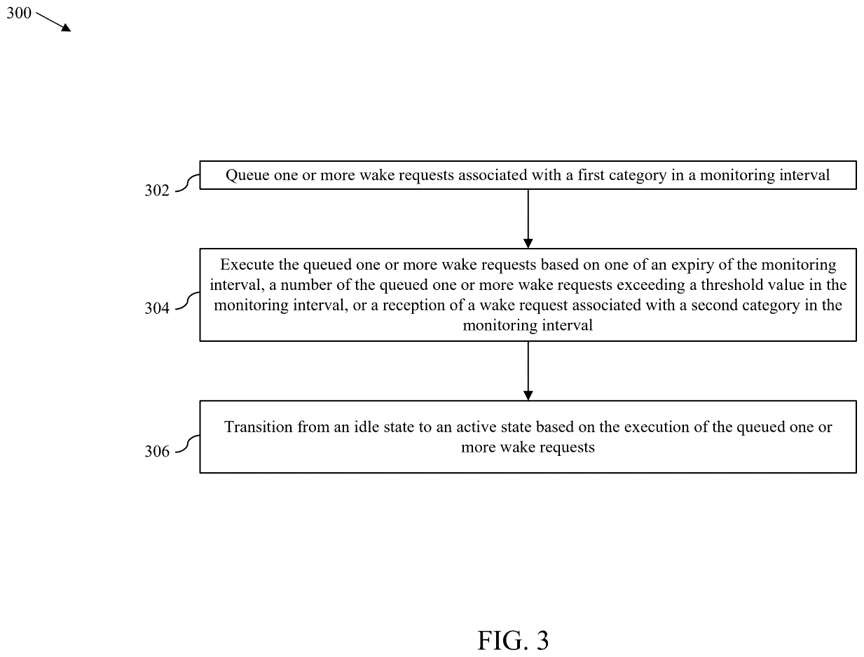

FIG. 3 is a high-level flowchart 300 that illustrates a method (e.g., a process) executed at the device 100 of FIG. 1, in accordance with an exemplary aspect of the present disclosure. FIG. 3 is explained in conjunction with FIG. 1-2.

At 302, one or more wake requests associated with a first category in a monitoring interval may be queued. The host SoC 102 may queue in the monitoring interval, the one or more wake requests associated with the first category in the buffer 118.

At 304, the queued one or more wake requests may be executed based on one of an expiry of the monitoring interval, a number of the queued one or more wake requests exceeding a threshold value in the monitoring interval, or a reception of a wake request associated with a second category in the monitoring interval. The first category wake requests may be executed based on any one of the aforesaid criteria occurring prior to the remaining criteria to generate the wake-up signal. The wake-up signal may be provided to the one or more processing circuits 106 via the connectivity interface 104.

At 306, the one or more processing circuits 106 may transition from an idle state to an active state based on the execution of the queued one or more wake requests. The one or more processing circuits 106 may receive the wake-up signal thereby transitioning from the idle state to the active state. Thus, the device 100 may transition from the first operational state to the second operational state

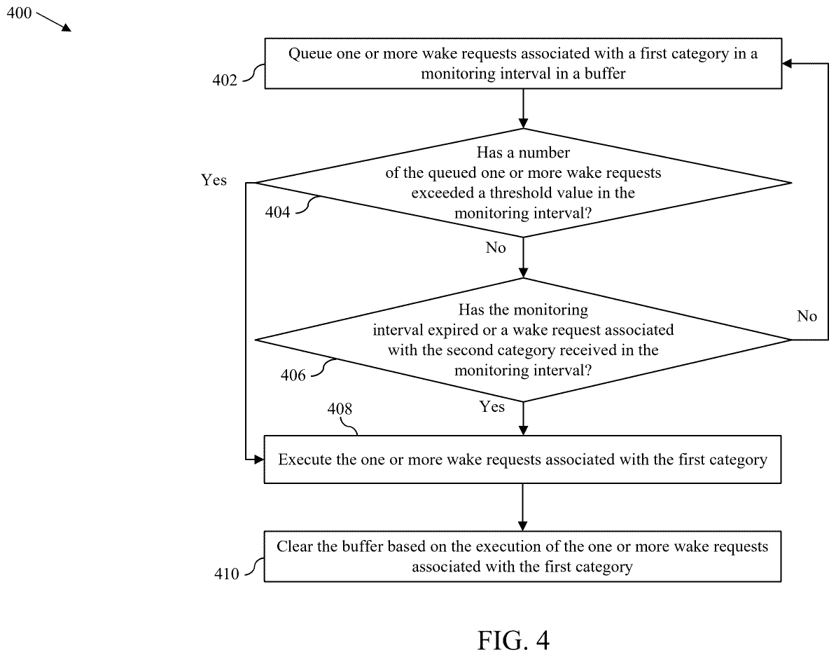

FIG. 4 is a flowchart 400 that illustrates a method (e.g., a process) executed by the host SoC 102 of FIG. 2 based on a number of low priority wake requests exceeding a threshold value, in accordance with an exemplary aspect of the present disclosure. FIG. 4 is explained in conjunction with FIG. 1-3.

At 402, one or more wake requests associated with a first category in a monitoring interval may be queued in a buffer 118. The event control circuit 114 may queue the one or more wake requests associated with the first category (e.g., low priority wake requests) based on reception of an initial wake request associated with the first category. The remaining wake requests associated with the first category may be queued after the initial wake request based on the reception of each remaining wake request.

At 404, it may be determined whether a number of the queued one or more wake requests exceeds a threshold value in the monitoring interval. The event control circuit 114 may determine with the reception of each request in the monitoring interval, whether the number of the queued one or more wake requests may exceed the threshold value. If at 404, it is determined that the number of the queued one or more wake requests does not exceed the threshold value in the monitoring interval, 406 may be executed. If at 404, it is determined that the number of the queued one or more wake requests does exceed the threshold value in the monitoring interval, 408 may be executed.

At 406, it may be determined whether the monitoring interval has expired, or a wake request associated with the second category has been received in the monitoring interval. The event control circuit 114 may determine whether the monitoring interval has expired, or the wake request associated with the second category has been received in the monitoring interval. If at 406, it may be determined that the monitoring interval has expired or the wake request associated with the second category has been received in the monitoring interval, 408 may be executed. However, if at 406, it may be determined that neither the monitoring interval has expired nor the wake request associated with the second category has been received in the monitoring interval, 402 may be executed to queue the remaining wake requests associated with the first category.

At 408, the one or more wake requests associated with the first category may be executed. The event control circuit 114 may execute the one or more wake requests associated with the first category.

At 410, the buffer 118 may be cleared based on the execution of the one or more wake requests associated with the first category. The event control circuit 114 may clear the buffer 118 based on the generation of the wake-up signal.

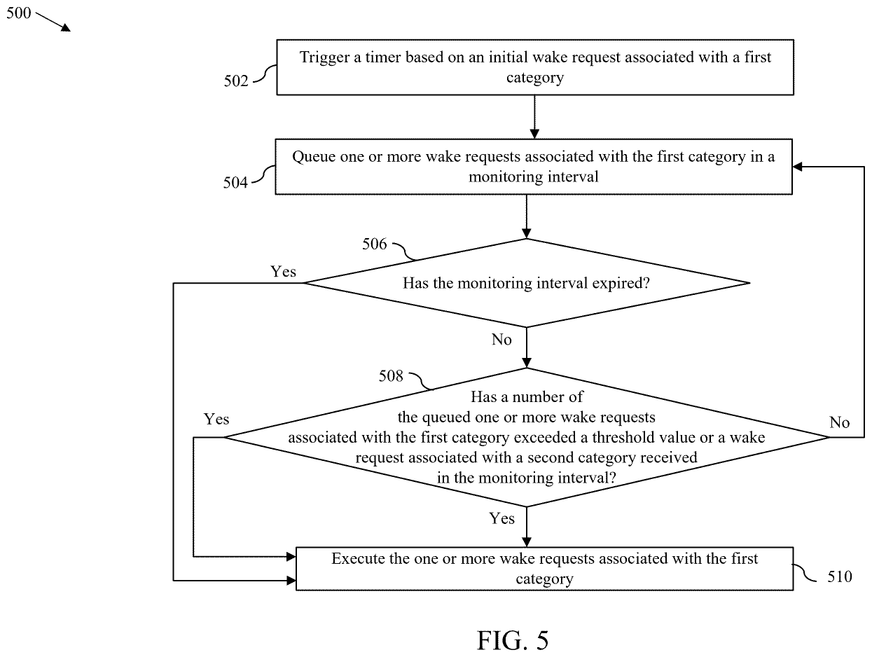

FIG. 5 is a flowchart 500 that illustrates a method (e.g., a process) executed by the host SoC 102 of FIG. 2 based on an expiry of a monitoring interval, in accordance with further aspects of the present disclosure. FIG. 5 is explained in conjunction with FIG. 1-4.

At 502, a timer 116 may be triggered based on an initial wake request associated with a first category. The event control circuit 114 may trigger the timer 116 based on the reception of the initial wake request associated with the first category. The timer 116 may thus be incremented until the expiry of the monitoring interval. The timer 116 may be a linear timer or a logarithmic timer.

At 504, one or more wake requests associated with the first category in a monitoring interval may be queued. The event control circuit 114 may queue the one or more wake requests associated with the first category in the buffer 118 based on the initial wake request.

At 506, it may be determined whether the monitoring interval has expired. The timer 116 may generate the timeout signal indicating the expiry of the monitoring interval. The event control circuit 114 may determine if the timeout signal has been generated to further determine the expiry of the monitoring interval. If at 506, it may be determined that the monitoring interval has not expired, 508 may be executed. If at 506, it may be determined that the monitoring interval has expired, 510 may be executed.

At 508, it may be determined whether a number of the queued one or more wake requests associated with the first category has exceeded a threshold value or a wake request associated with a second category is received in the monitoring interval. The event control circuit 114 may determine whether the number of the queued one or more wake requests associated with the first category has exceeded the threshold value in the buffer 118 or the wake request associated with the second category is received in the monitoring interval. If at 508, it may be determined that the number of the queued one or more wake requests associated with the first category has not exceeded the threshold value or the wake request associated with the second category is not received in the monitoring interval, 504 may be executed. If at 508, it may be determined that the number of the queued one or more wake requests associated with the first category has exceeded the threshold value or the wake request associated with the second category is received in the monitoring interval, 510 may be executed.

At 510, the one or more wake requests associated with the first category may be executed. The event control circuit 114 may execute the one or more wake requests associated with the first category based on the generation of the wake-up signal.

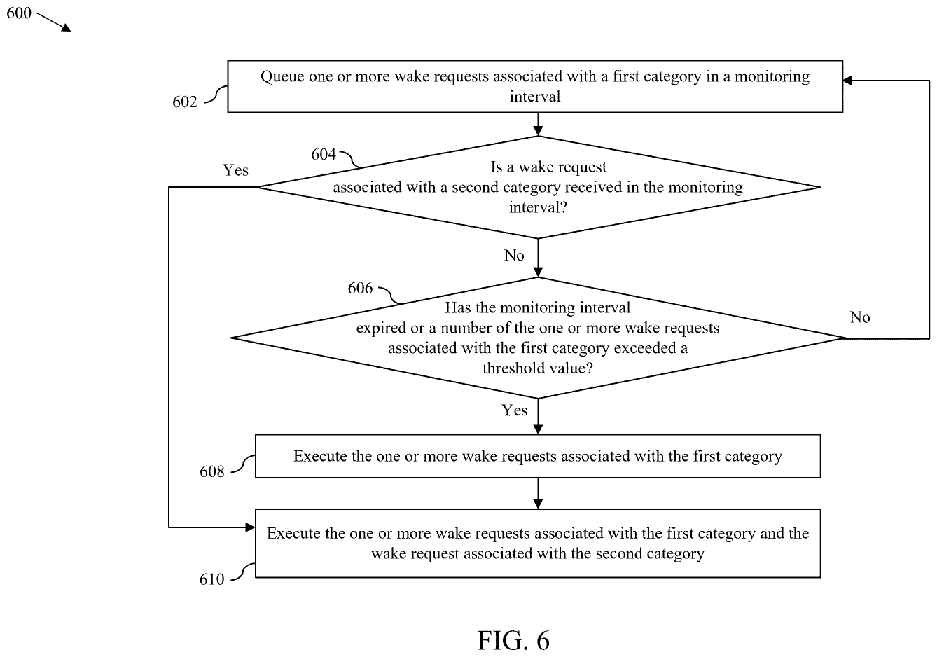

FIG. 6 is a flowchart 600 that illustrates a method (e.g., a process) executed by the host SoC 102 of FIG. 2 based on a high priority wake request, in accordance with furthermore aspects of the present disclosure. FIG. 6 is explained in conjunction with FIG. 1-5.

At 602, one or more wake requests associated with a first category in a monitoring interval may be queued. The event control circuit 114 may queue the one or more wake requests associated with the first category in the buffer 118.

At 604, it may be determined whether a wake request associated with a second category (e.g., a high priority wake request) is received in the monitoring interval. The event control circuit 114 may determine whether the wake request associated with the second category may be received from any of the network interface circuitry 112 or the user interface circuitry 110, in the monitoring interval. If at 604, it may be determined that wake request associated with the second category is not received in the monitoring interval, 606 may be executed.

At 606, it may be determined whether the monitoring interval has expired or a number of the one or more wake requests associated with the first category has exceeded a threshold value. The event control circuit 114 may determine whether the monitoring interval has expired based on the timeout signal or the number of the one or more wake requests associated with the first category has exceeded the threshold value based on the queued one or more wake requests in the buffer 118. If at 606, it may be determined that the monitoring interval has expired or the number of the one or more wake requests associated with the first category has exceeded the threshold value, 608 may be executed. Further, if at 606, it may be determined that monitoring interval has not expired or the number of the one or more wake requests associated with the first category has not exceeded the threshold value, 602 may be executed.

At 608, the one or more wake requests associated with the first category may be executed. The event control circuit 114 may execute the one or more wake requests associated with the first category.

At 610, the one or more wake requests associated with the first category and the wake request associated with the second category may be executed. At 604, if it may be determined that wake request associated with the second category is received in the monitoring interval, 610 may be executed. The event control circuit 114 may execute the one or more wake requests associated with the first category and the wake request associated with the second category.

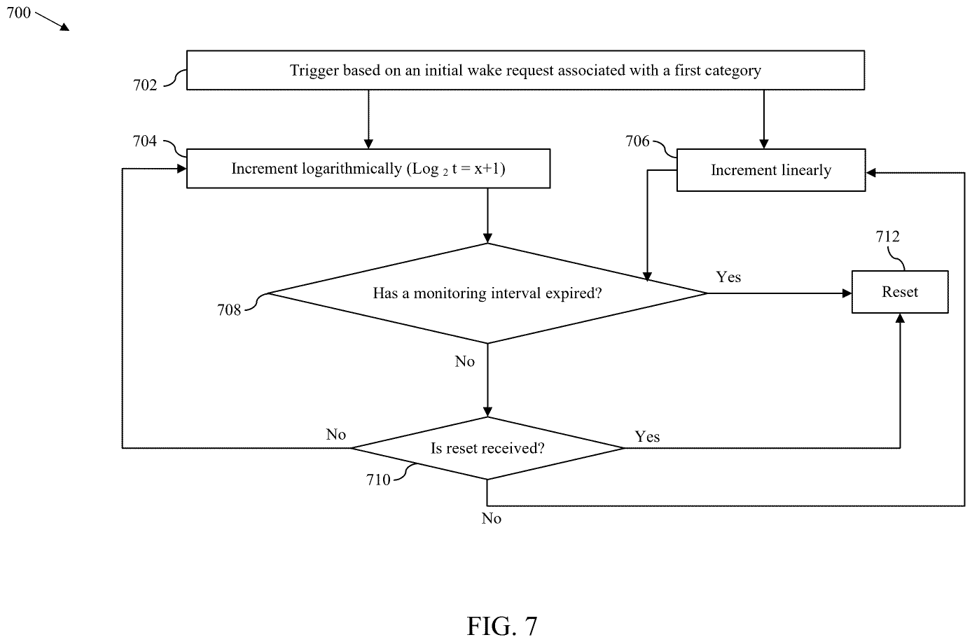

FIG. 7 is a flowchart 700 that illustrates a method (e.g., a process) executed by a timer 116 of the host SoC 102 of FIG. 2, in accordance with an exemplary aspect of the present disclosure. FIG. 7 is explained in conjunction with FIG. 1-6.

At 702, based on an initial wake request associated with a first category, the timer 116 may be triggered. The event control circuit 114 may trigger the timer 116 based on the reception of the initial wake request associated with the first category. After 702, 704 or 706 may be executed. If the timer 116 is a logarithmic timer, 704 may be executed after 702. However, if the timer 116 is a linear timer, 706 may be executed after 702.

At 704, the timer 116 may increment logarithmically (e.g., Log₂t=x+1). The timer 116 may increment until the expiry of the monitoring interval. In one aspect, the timer 116 may increment until the first time period. Further, the timer 116 may increment until the second time period after an end of the first time period. The second time period may be a logarithmic increment of the first time period. The logarithmic increment may refer to an exponential rise of the monitoring interval as compared to a linear rise.

At 706, the timer 116 may increment linearly. The timer 116 may increment linearly until the expiry of the monitoring interval.

At 708, it may be identified whether a monitoring interval has expired. 708 may occur after either 704 or 706. The timer 116 may identify whether the monitoring interval has expired. The timer 116 may generate the timeout signal at the end of the monitoring interval indicating that the monitoring interval has expired. The timer 116 may provide the timeout signal to the event control circuit 114. If at 708, it is identified that the monitoring interval has not expired, 710 may be executed. However, if it is determined at 708 that the monitoring interval has expired, 712 may be executed.

At 710, it is determined whether a reset is received. The timer 116 may receive a reset from the event control circuit 114. The reset may be provided to the timer 116 by the event control circuit 114, based on one of the number of the queued one or more wake requests exceeding the threshold value in the monitoring interval, or the reception of the wake request associated with the second category in the monitoring interval. If at 710, it may be determined that the reset is not received, 704 or 706 may be executed. However, if at 710, it may be determined that the reset is received, 712 may be executed.

At 712, the timer 116 may reset. The timer 116 may reset at an expiry of the monitoring interval or based on the reset received from the event control circuit 114. The timer 116 may be triggered again based on the reception of an initial wake request associated with the first category when the device 100 may be in the first operational state at a different time instance.

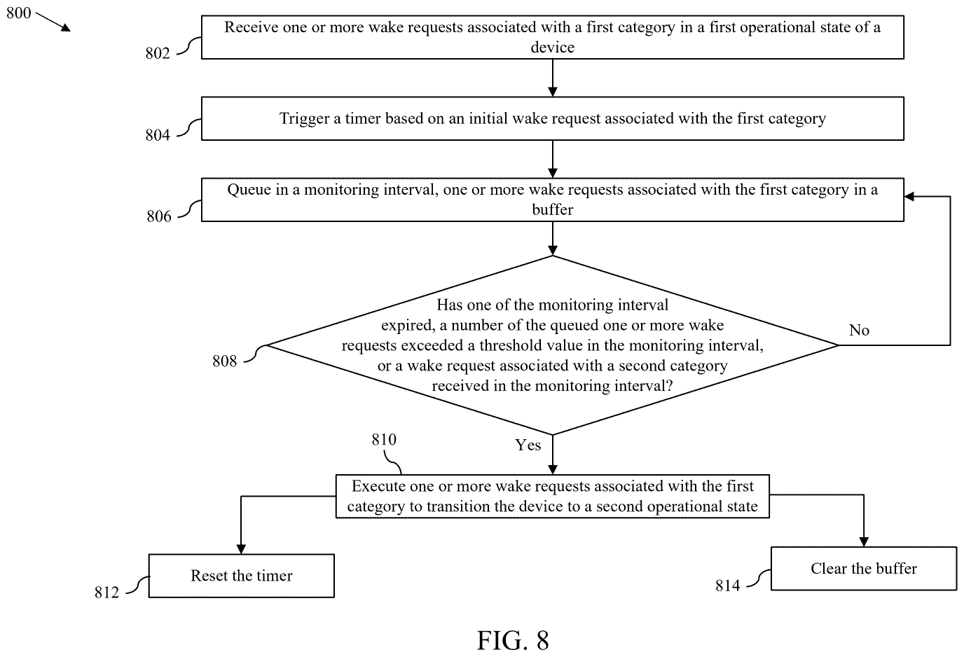

FIG. 8 is a flowchart 800 that illustrates a method (e.g., a process) executed by an event control circuit 114 of the host SoC 102 of FIG. 2, in accordance with an exemplary aspect of the present disclosure. FIG. 8 is explained in conjunction with FIG. 1-7.

At 802, one or more wake requests associated with a first category may be received in a first operational state of a device 100. The device 100 may be in an idle state. Any of the first through third requests may be initiated. The event control circuit 114 may thus receive any of the first through third requests as the initial wake request associated with the first category.

At 804, a timer 116 may be triggered, based on an initial wake request of the first category. The event control circuit 114 may trigger the timer 116 based on the initial wake request. The timer 116 may increment either linearly or logarithmically.

At 806, the one or more wake requests associated with the first category in a buffer 118 may be queued, in a monitoring interval. The initial wake request may be added to the buffer 118. Further requests associated with the first category may be added to the buffer 118 until one of the expiry of the monitoring interval, the number of the queued first category wake requests exceeding the threshold value in the monitoring interval, or the reception of the second category wake request in the monitoring interval.

At 808, it may be determined whether the monitoring interval has expired, a number of the queued one or more wake requests has exceeded a threshold value in the monitoring interval, or a wake request associated with a second category is received in the monitoring interval. The event control circuit 114 may determine whether the monitoring interval has expired based on the timeout signal from the timer 116. The event control circuit 114 may further determine whether the number of the queued one or more wake requests has exceeded the threshold value in the monitoring interval based on the queued one or more wake requests in the buffer 118. The event control circuit 114 may further determine whether at least one of the user interface circuitry 110 or the network interface circuitry 112 has generated the wake request associated with the second category in the monitoring interval. If it is determined that one of the monitoring interval has expired, the number of the queued one or more wake requests has exceeded the threshold value in the monitoring interval, or the wake request associated with the second category is received in the monitoring interval, 810 is performed. If it is determined that the monitoring interval has not expired, the number of the queued one or more wake requests has not exceeded the threshold value in the monitoring interval, or the wake request associated with the second category has not been received in the monitoring interval, 806 is executed to queue any remaining wake requests associated with the first category that may be received in the monitoring interval.

At 810, the one or more wake requests associated with the first category may be executed to transition the device 100 to a second operational state. The event control circuit 114 may execute the one or more wake requests associated with the first category to transition the one or more processing circuits 106 from the idle state to the active state thereby transitioning the device 100 from the first operational state to the second operational state. After 810, 812 and 814 may be executed concurrently.

At 812, the timer 116 may be reset. The timer 116 may reset at the expiry of the monitoring interval or based on the reset received from the event control circuit 114.

At 814, the buffer 118 may be cleared. The event control circuit 114 may clear the buffer 118 based on any of the criteria occurring prior to the remaining criteria.

Techniques consistent with the present disclosure provide, among other features, systems, and methods for management of wake requests in devices.

The host SoC 102 may determine the execution of the first category wake requests based on various criteria to combine the benefits offered by each criterion associated with the monitoring interval, the threshold value, or the second category wake request. Further, the wake requests associated with the first category are low priority wake requests and may be queued for execution thereby reducing the transitions of the device 100 from the first operational state to the second operational state. A performance of the device 100 may thus be improved based on the overlapping execution of multiple wake requests associated with the first category as compared to conventional solutions that wake-up the device 100 for each low priority wake request. In addition, the power consumed by the device 100 may be lower than conventional devices as the device 100 may remain for a longer time in the first operational state as compared to conventional devices. The frequent training of the connectivity interface 104 may be reduced as the connectivity interface 104 may be trained at once to execute the accumulated wake requests. Thus, the stability of the device 100 may be further improved. Further, the device 100 may be employed in a remote area where long battery life may be desired due to the aforementioned advantages.

Some implementation examples are described in the following numbered aspects:

Aspect 1: A method executed by an event control circuit, the method comprising queueing, one or more wake requests associated with a first category, in a monitoring interval; and executing the queued one or more wake requests based on one of: an expiry of the monitoring interval, a number of the queued one or more wake requests exceeding a threshold value in the monitoring interval, or a reception of a wake request associated with a second category in the monitoring interval.

Aspect 2: The method of aspect 1, further comprising generating the one or more wake requests associated with the first category.

Aspect 3: The method of any of aspects 1 to 2, wherein the one or more wake requests associated with the first category are different from the wake request associated with the second category.

Aspect 4: The method of aspect 1, further comprising receiving the wake request associated with the second category.

Aspect 5: The method of aspect 4, wherein the wake request associated with the second category includes at least one of a user-initiated wake request or a network-initiated wake request.

Aspect 6: The method of any of aspects 1 to 5, wherein the first category is indicative of a first priority level and the second category is indicative of a second priority level, and wherein the second priority level is higher than the first priority level.

Aspect 7: The method of any of aspects 1 to 6, further comprising queueing the one or more wake requests in the buffer.

Aspect 8: The method of aspect 7, further comprising clearing the buffer based on the execution of the queued one or more wake requests.

Aspect 9: The method of any of aspects 7 or 8, further comprising determining whether the number of the queued one or more wake requests has exceeded the threshold value in the monitoring interval, based on the queued one or more wake requests in the buffer; and executing the queued one or more wake requests based on the determination that the number of the queued one or more wake requests has exceeded the threshold value.

Aspect 10: The method of any of aspects 1 to 9, wherein a timer is associated with the monitoring interval.

Aspect 11: The method of aspect 10, further comprising triggering the timer based on an initial wake request of the one or more wake requests associated with the first category.

Aspect 12: The method of aspect 11, the timer is configured to be incremented linearly until one of: the expiry of the monitoring interval, the number of the queued one or more wake requests exceeding the threshold value in the monitoring interval, or the reception of the wake request associated with the second category in the monitoring interval.

Aspect 13: The method of aspect 11, wherein the timer is configured to be incremented logarithmically until one of: the expiry of the monitoring interval, the number of the queued one or more wake requests exceeding the threshold value in the monitoring interval, or the reception of the wake request associated with the second category in the monitoring interval.

Aspect 14: The method of any of aspects 11 to 13, wherein the timer is configured to be reset based on the expiry of the monitoring interval.

Aspect 15: The method of any of aspects 11 to 13, further comprising resetting the timer based on one of: the number of the queued one or more wake requests exceeding the threshold value in the monitoring interval, or the reception of the wake request associated with the second category in the monitoring interval.

Aspect 16: The method of any of aspects 1 to 15, further comprising setting the monitoring interval based on one or more operational parameters associated with an SoC.

Aspect 17: The method of any of aspects 1 to 16, wherein the one or more wake requests associated with the first category include at least one of a location-based wake request, a diagnosis-based wake request, or a debug-based wake request.

Aspect 18: The method of any of aspects 1 to 17, further comprising setting the threshold value based on one or more operational parameters associated with an SoC that includes the event control circuit.

Aspect 19: The method of any of aspects 1 to 18, further comprising executing the queued one or more wake requests based on one of: the expiry of the monitoring interval prior to the number of the queued one or more wake requests exceeding the threshold value or the reception of the wake request associated with the second category, the number of the queued one or more wake requests exceeding the threshold value in the monitoring interval prior to the expiry of the monitoring interval or the reception of the wake request associated with the second category, or the reception of the wake request associated with the second category in the monitoring interval prior to the expiry of the monitoring interval or the number of the queued one or more wake requests exceeding the threshold value.

Aspect 20: The method of any of aspects 1 through 19, further comprising receiving the one or more wake requests in a first operational state of a device that includes the event control circuit, wherein the device transitions to a second operational state based on at least one of: the execution of the one or more wake requests associated with the first category, or the reception of the wake request associated with the second category and the execution of the one or more wake requests associated with the first category

Aspect 21: A method executed at a device, the method comprising: queueing by a host system-on-chip (SoC), one or more wake requests associated with a first category, in a monitoring interval; executing by the host SoC, the queued one or more wake requests based on one of: an expiry of the monitoring interval, a number of the queued one or more wake requests exceeding a threshold value in the monitoring interval, or a reception of a wake request associated with a second category in the monitoring interval; and transitioning by one or more processing circuits from an idle mode to an active mode based on the execution of the queued one or more wake requests.

Aspect 22: The method of aspect 21, wherein the queued one or more wake requests are executed based on one of: the expiry of the monitoring interval prior to the number of the queued one or more wake requests exceeding the threshold value or the reception of the wake request associated with the second category, the number of the queued one or more wake requests exceeding the threshold value in the monitoring interval prior to the expiry of the monitoring interval or the reception of the wake request associated with the second category, or the reception of the wake request associated with the second category in the monitoring interval prior to the expiry of the monitoring interval or the number of the queued one or more wake requests exceeding the threshold value.

Aspect 23: The method of any of aspects 21 or 22, wherein the wake request associated with the second category includes at least one of a user-initiated wake request or a network-initiated wake request.

Aspect 24: The method of any of aspects 21 through 23, wherein the first category is indicative of a first priority level and the second category is indicative of a second priority level, and wherein the second priority level is higher than the first priority level.

Aspect 25: The method of any of aspects 21 through 23, wherein the wake request associated with the second category is different than the one or more wake requests associated with the first category.

Aspect 26: The method of any of aspects 21 through 25, further comprising setting the monitoring interval based on one or more operational parameters associated with the host SoC.

Aspect 27: The method of any of aspects 21 through 26, further comprising setting the threshold value based on one or more operational parameters associated with the host SoC.

Aspect 28: An apparatus comprising: a processor; a memory coupled with the processor; and instructions stored in the memory and executable by the processor to cause the apparatus to perform a method of any of aspects 1 through 20.

Aspect 29: An apparatus for managing wake requests, comprising at least one means for performing a method of any of aspects 1 through 20.

Aspect 30: A non-transitory computer-readable medium storing code for managing wake requests, the code comprising instructions executable by a processor to perform a method of any of aspects 1 through 20.

Aspect 31: An apparatus comprising: a processor; a memory coupled with the processor; and instructions stored in the memory and executable by the processor to cause the apparatus to perform a method of any of aspects 21 through 27.

Aspect 32: An apparatus for managing wake requests, comprising at least one means for performing a method of any of aspects 21 through 27.

Aspect 33: A non-transitory computer-readable medium storing code for managing wake requests, the code comprising instructions executable by a processor to perform a method of any of aspects 21 through 27.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more”. As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C).

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A system-on-chip (SoC), comprising:
an event control circuit configured to:
queue one or more wake requests associated with a first category, in a monitoring interval; and
execute the queued one or more wake requests based on one of:
an expiry of the monitoring interval,
a number of the queued one or more wake requests exceeding a threshold value in the monitoring interval, or
a reception of a wake request associated with a second category in the monitoring interval.

2. The SoC of claim 1, wherein the SoC is further configured to generate the one or more wake requests associated with the first category.

3. The SoC of claim 1, wherein the event control circuit is further configured to receive the wake request associated with the second category, and wherein the wake request associated with the second category includes at least one of a user-initiated wake request or a network-initiated wake request.

4. The SoC of claim 1, wherein the one or more wake requests associated with the first category are different from the wake request associated with the second category.

5. The SoC of claim 1, wherein the first category is indicative of a first priority level and the second category is indicative of a second priority level, and wherein the second priority level is higher than the first priority level.

6. The SoC of claim 1, further comprising a buffer, wherein the event control circuit is further configured to queue the one or more wake requests in the buffer.

7. The SoC of claim 6, wherein the event control circuit is further configured to clear the buffer based on the execution of the queued one or more wake requests.

8. The SoC of claim 6, wherein the event control circuit is further configured to:
determine whether the number of the queued one or more wake requests has exceeded the threshold value in the monitoring interval, based on the queued one or more wake requests in the buffer; and
execute the queued one or more wake requests based on the determination that the number of the queued one or more wake requests has exceeded the threshold value.

9. The SoC of claim 1, further comprising a timer associated with the monitoring interval, wherein the event control circuit is further configured to trigger the timer based on an initial wake request of the one or more wake requests associated with the first category.

10. The SoC of claim 9, wherein the timer is configured to be incremented linearly until one of:
the expiry of the monitoring interval,
the number of the queued one or more wake requests exceeds the threshold value in the monitoring interval, or the reception of the wake request associated with the second category in the monitoring interval.

11. The SoC of claim 9, wherein the timer is configured to be incremented logarithmically until one of:
the expiry of the monitoring interval,
the number of the queued one or more wake requests exceeds the threshold value in the monitoring interval, or
the reception of the wake request associated with the second category in the monitoring interval.

12. The SoC of claim 9, wherein the timer is configured to be reset based on the expiry of the monitoring interval.

13. The SoC of claim 9, wherein the event control circuit is further configured to reset the timer based on one of:
the number of the queued one or more wake requests exceeding the threshold value in the monitoring interval, or
the reception of the wake request associated with the second category in the monitoring interval.

14. The SoC of claim 9, wherein the event control circuit is further configured to set the monitoring interval based on one or more operational parameters associated with the SoC.

15. The SoC of claim 1, wherein the one or more wake requests associated with the first category include at least one of a location-based wake request, a diagnosis-based wake request, or a debug-based wake request.

16. The SoC of claim 1, wherein the event control circuit is further configured to set the threshold value based on one or more operational parameters associated with the SoC.

17. The SoC of claim 1, wherein the event control circuit is further configured to execute the queued one or more wake requests based on one of:
the expiry of the monitoring interval prior to the number of the queued one or more wake requests exceeding the threshold value or the reception of the wake request associated with the second category,
the number of the queued one or more wake requests exceeding the threshold value in the monitoring interval prior to the expiry of the monitoring interval or the reception of the wake request associated with the second category, or
the reception of the wake request associated with the second category in the monitoring interval prior to the expiry of the monitoring interval or the number of the queued one or more wake requests exceeding the threshold value.

18. The SoC of claim 1, wherein the SoC is included in a device, and wherein the event control circuit is further configured to receive the one or more wake requests in a first operational state of the device, and wherein the device transitions to a second operational state based on at least one of:
the execution of the one or more wake requests associated with the first category, or
the reception of the wake request associated with the second category and the execution of the one or more wake requests associated with the first category.

19. A device, comprising:
a host system-on-chip (SoC) configured to:
queue one or more wake requests associated with a first category, in a monitoring interval; and
execute the queued one or more wake requests based on one of:
an expiry of the monitoring interval,
a number of the queued one or more wake requests exceeding a threshold value in the monitoring interval, or
a reception of a wake request associated with a second category in the monitoring interval;
a connectivity interface; and
one or more processing circuits coupled to the host SoC via the connectivity interface, wherein the one or more processing circuits are configured to transition from an idle mode to an active mode based on the execution of the queued one or more wake requests.

20. A method executed by a system-on-chip, the method comprising:
queueing one or more wake requests associated with a first category, in a monitoring interval; and
executing the queued one or more wake requests based on one of:
an expiry of the monitoring interval,
a number of the queued one or more wake requests exceeding a threshold value in the monitoring interval, or
a reception of a wake request associated with a second category in the monitoring interval.
